(19) United States
(12) Patent Application Publication
(10) Pub. No.: US 2021/0276214 A1
(43) Pub. Date: Sep. 9, 2021

(54) METHOD OF CUTTING ACCURATE DESIGNS IN CNC MACHINE USING HOT-WIRE/EDM METHODS

(71) Applicant: VISWESH SRINIVASAN, Chennai (IN)

(72) Inventor: VISWESH SRINIVASAN, Chennai (IN)

(21) Appl. No.: 16/604,645

(22) PCT Filed: Apr. 11, 2018
(86) PCT No.: PCT/IN2018/050208

§ 371 Date: Oct. 11, 2019

(30) Foreign Application Priority Data
Apr. 11, 2017 (IN) 201741012944
Apr. 11, 2017 (IN) 201741013059

(51) Int. Cl. B26D 1/553; B26D 5/00; G05B 19/4093

(52) U.S. Cl. CPC B26D 1/553; B26F 3/12; G05B 19/4093; B26D 5/005

(57) ABSTRACT

In conventional machining process, it is sometimes desirable to cut internal features with sharp corners. But normal machining process using end mills fail to achieve sharp corners, as they leave a fillet material equal to tool radius unmachined. In this invention, it is proposed to design a special tool and a 4-axis robotic handling system, to achieve sharp corner radius even for internal features, at the same time achieving high material removal rates. An intelligent cutting method is proposed in this invention for cutting big blocks of materials using multiple wires. The proposed method provides several benefits like achieving high dimensional accuracies, sharp corners, easy to handle shredded scrap materials etc. A method for automatically generating the cutting tool path for single and multiple nested pipes is also proposed.

### FIELD OF INVENTION

This invention relates to the field of CNC profile cutting. This invention proposes a special tool and cutting method, which achieves sharp inner corners in parts manufactured in CNC machines. This invention also proposes an intelligent cutting method, which results in dimensionally accurate parts when using multiple cutting tools/wires. The present application is based on, and claims priority from an Indian Application Number, 201741012944 filed on 11^{th} Apr., 2017 and 201741013059 filed on 11^{th} Apr., 2017, the disclosure of which is hereby incorporated by reference herein.

### BACKGROUND OF INVENTION

In CNC profile cutting machines, it is often required to cut sharp inner corners.

But in processes like milling, fillet material equal to tool radius is left unmachined.

To achieve sharp corners, sometimes tool of small diameter is used. But this results in slow material removal rate and the small tool can break easily.

Other processes like EDM spark erosion using dies are expensive and slow and need custom dies to be made for each shape.

Hence there is a need to develop a new tool and cutting method, which can achieve sharp corners and also achieve high material removal rate.

In CNC profile cutting machines, it is often required to cut designs/shapes from a block of material. It is often required to use multiple wires, to increase production speed.

Examples of wire cutting are: EPS material being cut by hot wire process, PUF material being cut by abrasive wire, Metals being cut by wire EDM process etc. These processes are given as examples, but this invention also applies to various other materials and processes, where one or more tools/wires are used to cut a block of raw material.

When cutting with multiple wires, often the top and bottom support for the material is severed during the cut. Only connection available is to the right side of the block. This results in parts sagging down because of self-weight, resulting in displacement with respect to the cutting wire and hence loss in dimensional accuracy of the cut parts.

Also, during wire cutting process, due to variation in material hardness, the wire can lag behind the CNC path, resulting in jointed/un-cut materials at corners, where wire changes cutting direction.

Also, the scrap material is often bulky and difficult to handle for disposal.

Hence there is a need to develop an intelligent cutting method, which will overcome the above problems and automatically generate the optimal tool path as per the user choice.

### OBJECT OF INVENTION

The principal object of this invention is to develop a cutting tool and method that can achieve sharp inner corners.

Another objective of the invention is to achieve high material removal rate, while achieving sharp inner corners.

Another objective of the invention is to achieve ability to cut/machine geometric features smaller than the major tool diameter.

Another object of this invention is to develop an intelligent cutting method to achieve dimensionally accurate parts when cutting big blocks using multiple cutting wires.

Another objective of the invention is to develop a method of achieving sharp, dis-jointed/clean cut corner features, without formation of errors like corner radius.

Another objective of the invention is to develop an intelligent cutting method, that will result in non-bulky scrap material that will be easy to handle for disposal.

These and other objects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF FIGURES

This invention is illustrated in the accompanying drawings, throughout which like reference letters indicate corresponding parts in the various figures. The embodiments herein will be better understood from the following description with reference to the drawings, in which:

FIG. 1 depicts conventional milling with cylindrical shaped end mill. The corner fillets can be observed.

FIG. 2 depicts the proposed new tool with major diameter D, cutting edge diameter d and hollow portion 103 etc.

FIG. 3 depicts different shape possibilities of proposed tool

FIG. 4 illustrates the path for cutting geometric features smaller that the tool major dia.

FIGS. 5 & 6 illustrates the proposed new tool path, by a CNC system manipulating the tool simultaneously in X, Y&THEETA axis.

FIG. 7 depicts a block of raw material being cut by multiple cutting wires.

FIG. 8 depicts a typical cutting path which results in dimensional problems.

FIG. 9 depicts another typical cutting path which results in dimensional inaccuracies.

FIG. 10 illustrates the proposed intelligent cutting path which results in higher dimensional accuracy.

FIG. 11 illustrates the proposed intelligent cutting path which results in higher dimensional accuracy when cutting multiple nested pipe geometries.

FIG. 12 illustrates process parameters D1 and D2 typically measured by user.

FIG.13. Illustrates how intelligent toolpath can shred the scrap material efficiently.

### DETAILED DESCRIPTION OF INVENTION

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. For example, it should be noted that while some embodiments are explained with respect to scooping of EPS material using Heated wire, any other application may also incorporate the subject matter of the invention with little or no modifications. Accordingly, the examples should not be construed as limiting the scope of the embodiments herein.

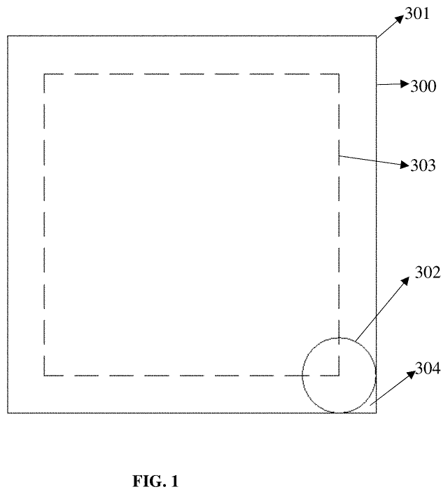

The embodiments herein describe an intelligent automated cutting method for cutting sharp inner corners, maintaining high material removal rate. Referring now to the drawings, and more particularly to FIGS. 1 through 6, where similar reference characters denote corresponding features consistently throughout the figures, there are shown embodiments.

FIG. 1 illustrates the conventional tool path (303) for machining a rectangular inner pocket (300) using a conventional cylindrical endmill (302). In this process, some material (304) is left unmachined, resulting in a non-sharp filleted corner (304).

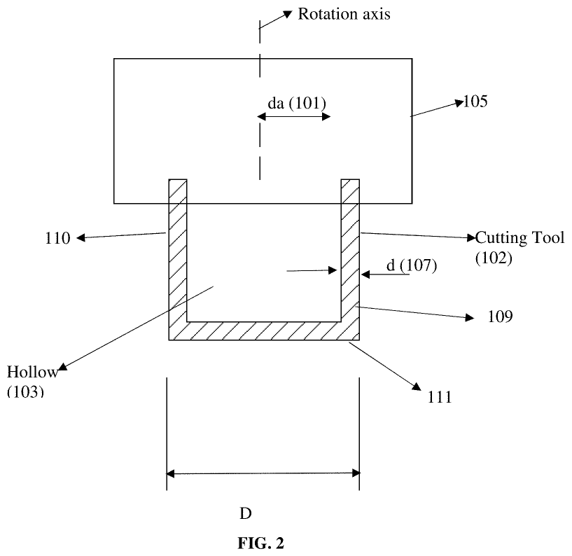

FIG. 2 shows the proposed tool 100, in which a thin cutting edge (102) is bent typically in the shape of a loop, leaving a hollow portion (103) in between the cutting edges. FIG. 2 shows Right cutting edge 109, Left cutting edge 110 & Bottom cutting edge 111. The loop is typically in the shape of a square or circular “U”, but not limited to this shape.

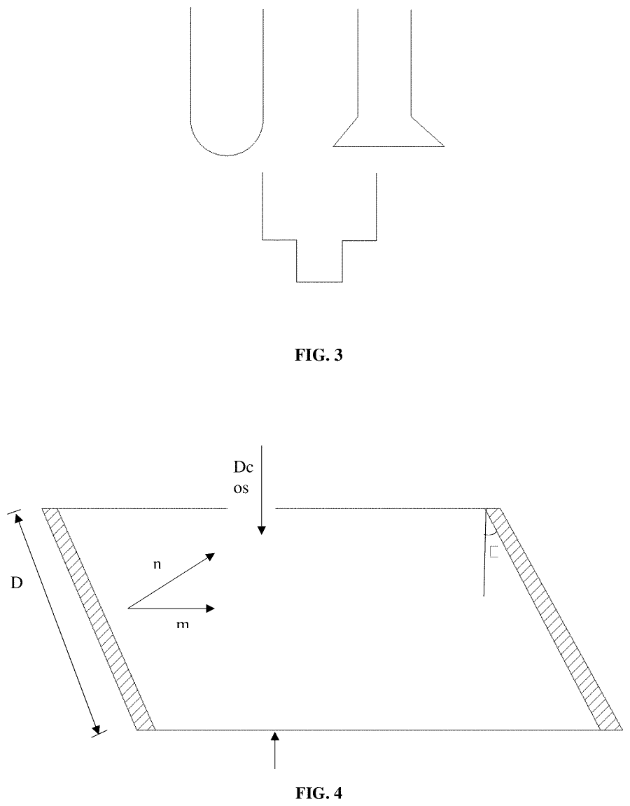

FIG. 3 shows some possible sample shapes of the loop in the cutting tool.

The looped tool 102 is mounted on a tool holder 105.

The tool holder 105 is in turn mounted on the rotary axis 106, whose position is accurately controlled by a CNC. The rotary axis is in turn mounted on XYZ axis of a typical CNC machine.

The major dimension of the looped wire is D (104) and minor dimension is d (107).

The rotary axis 106 can be typically at the center of the bottom cutting edge 111 OR can be at any distance da (101) from the center of the cutting tool. In another embodiment of the proposed invention, the Rotary axis will be aligned to the right cutting edge 109.

The tool 100 is typically mounted on a CNC motion system, capable of manipulating/moving the tool in X, Y, Z & Theeta directions.

FIG. 4 shows the top view of the tool, where the normal vector (n) to the tool is at an angle theta to the motion direction (m). In this case the width of material scooped/removed by the tool is D*cos(theta).

Thus, by controlling the tool angle theta, slot of width smaller than the tool major dia D(104) can be machined/scooped by the tool.

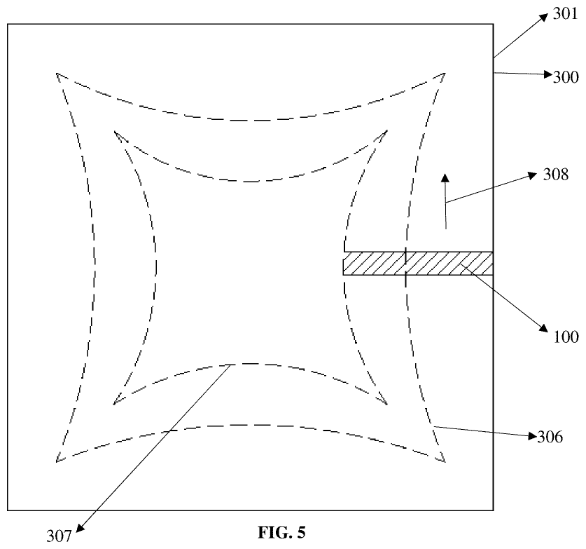

FIG. 5 shows the proposed tool path 306 followed by the tool 100 for machining a rectangular inner pocket 300 with sharp corner. The path is computed such that one of the cutting edges say 109 is always moved along the geometry 300. The opposite cutting edge 110 is manipulated by controlling angle theta, to avoid intersection of the tool with geometry 300 being cut.

The tool movement along X, Y, Z & theta is achieved by the proposed 4-axis motion control system 400 (including Z -axis for depth control) with computational intelligence to calculate the tool path to achieve sharp corners as shown in FIGS. 5 & 6.

The path 307 of the left edge 110 of the tool is calculated and stored by the proposed system. This path 307 is the left-over material (if any), which can be removed/machined in the next cut-sequence.

The orientation of the tool theta is carefully manipulated to avoid any intersection with the original geometry 300, also maintaining distance by avoiding the tail (110) of the tool from going very close to the original geometry, thus avoiding undercuts.

Thus, by suitable design of cutting tool and suitably programmed CNC motion system manipulating the tool, desired sharp inner corners are achieved.

Some examples of cutting tool are hot wire tool for scooping EPS, Spark erosion die for scooping electrical conducting metals etc. These are cited as examples, but the proposed system is not limited to these examples but is applicable for any process in which a sharp inner corner feature is required.

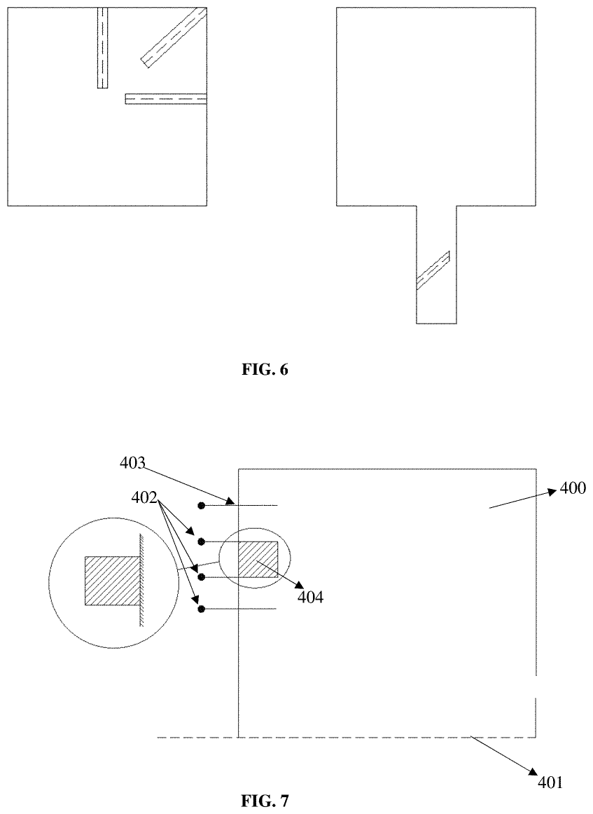

The embodiments herein describe an intelligent cutting method for cutting big block of material using multiple cutting wires, to achieve high dimensional accuracy. Referring now to the drawings, and more particularly to FIGS. 7 through 13, where similar reference characters denote corresponding features consistently throughout the figures, there are shown embodiments.

FIG. 7 illustrates a big block of raw material 400, clamped or resting on the ground support 401. Multiple cutting wires 402 are cutting the block along tool path 403. As can be seen in FIG. 7, the chunk of material 404 has lost its support at top and bottom and is hanging on because of support from raw material on the right side. Hence it behaves like a cantilevered object with right side support.

It is important to plan the tool path such that maximum bridging material is available between 404 & 400. If this support is compromised by the tool path, the piece 404 will sag down because of self-weight, shift position with respect to cutting wire and dimensions of the design will be affected.

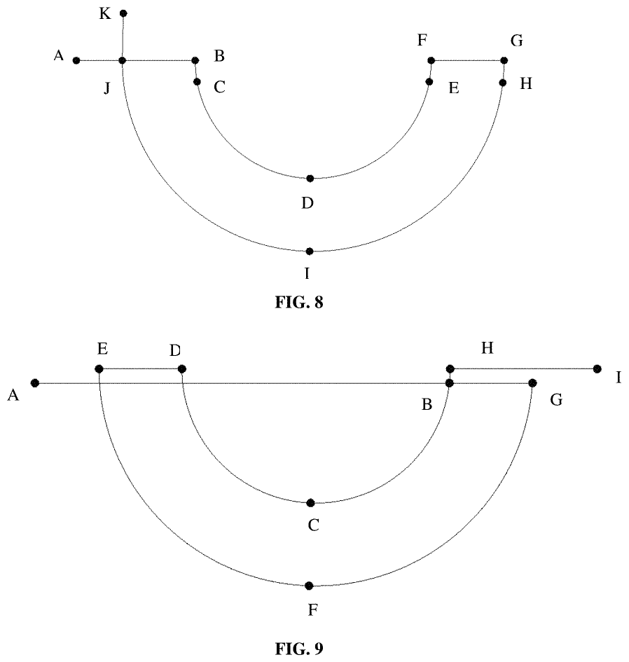

FIGS. 8 & 9 shows some example tool path for cutting half-pipe section designs in multistring hotwire machine. Such half-pipe sections are commonly used as insulation material in buildings and factories around metal pipes carrying hot/cold process fluids.

FIG. 8 shows cutting path ABCDEFGHIJK. In this path, after section GHI is cut, there is no support for the material, when subsequent path IJK is being cut. This will result in part sagging and dimensional accuracy loss.

FIG. 9 shows cutting path ABCDEFGBHI. In this path, after section FG is cut, there is no support for the material, when subsequent path GB is being cut. This will result in part sagging and dimensional accuracy loss.

Hence there is a need to follow a systematic & automated toolpath generation system, which will guide the tool along the desired path, resulting in higher dimensional accuracies.

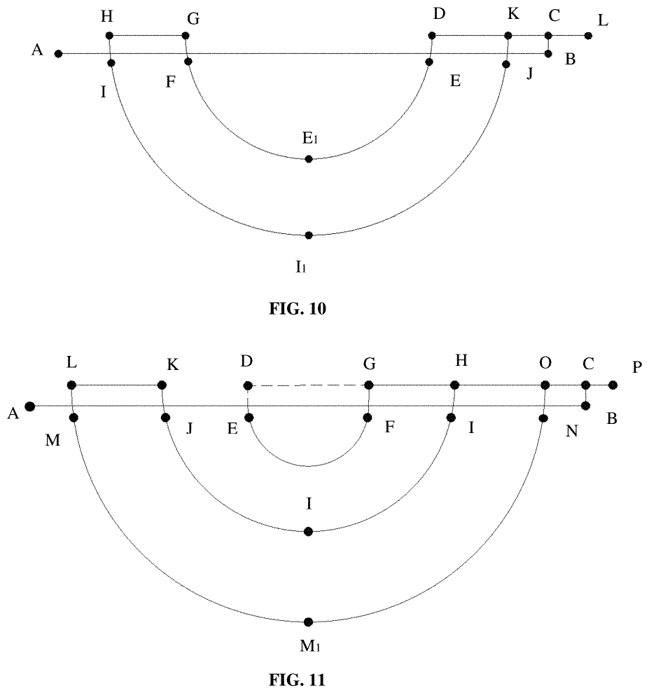

FIG. 10 shows path ABCDEFGHII1JKL. In this path, I1J is the last segment being cut in the required design. In this tool path, maximum support to the right-side material is maintained, till the last meaningful part of the cut geometry. This will result in minimal part sagging and higher dimensional accuracy.

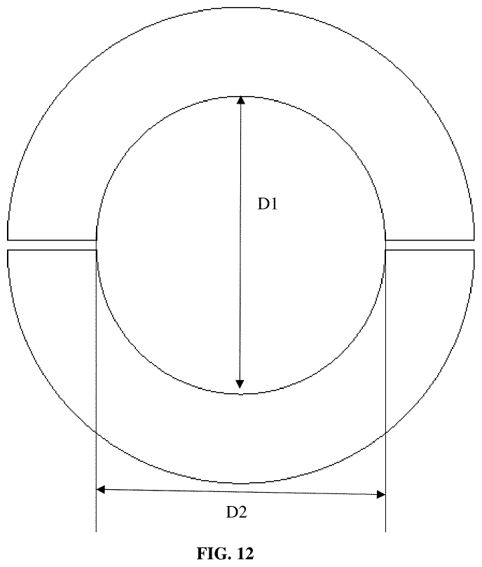

FIG. 11 shows path ABCDEFGHIJKLMM1NOP. In this path, M1N is the last segment being cut in the required design. In this tool path, maximum support to the right-side material is maintained, till the last meaningful part of the cut geometry. This will result in minimal part sagging and higher dimensional accuracy.

The same logic can be extended for multiple pipe-in-pipe cutting tool paths.

The cutting sequence can be generalized as follows. Starting at left, cut all across the half pipe in a straight-line motion to the right side of the pipe and overshoot by JB (in FIG. 10) or NB (in FIG. 11). Then move up. For odd number of pipes (1,3,5,7 etc.), move left till RIGHT TOP edge of inner pipe and start cutting the inner pipe as shown in FIG. 10. For even number of pipes (2,4,6,8 etc.), move left till LEFT TOP edge of inner pipe and start cutting the inner pipe as shown in FIG. 11.

Another advantage of the proposed tool path is that all corners are perfect right angle, un-jointed cuts, as the tool path cuts past edges, instead of stopping and turning at corners inside the geometry.

FIG. 13 shows tool path, where a vertical cut line (marked by a circle) is shown. This helps in severing or shredding the left-over scrap material into short, easy to handle pieces.

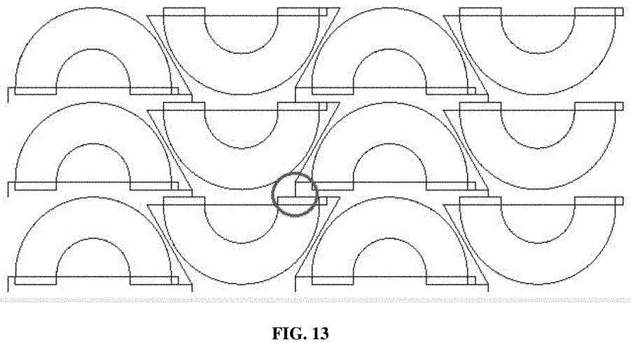

FIG. 12 shows two different parameters D1 and D2 typically measured by manufacturer for dimension verification. The dimensions are highly dependent on the effective tool diameter or kerf width. In processes like hot-wire cutting, melting rate affecting kerf-width depends on material density and moisture level and have to be practically measured and input to the system. If estimated kerf-width is less than the actual melting/kerfwidth, the D1<D (nominal diameter) and D2>D. If estimated kerf-width is more than the actual melting/kerfwidth, the D1>D (nominal diameter) and D2<D.

The proposed system will ask the user to input D1 & D2 & D values and automatically use correct kerf-width value for the toolpath computation.

In insulation industry, it is required to manufacture pipe sections of various sizes. Drawing toolpath manually for each pipe size and tool size (radius) is a very difficult task. An automatic system is proposed in this invention, which will generate the toolpath automatically as per details given in the above description.

While figures given here are for half-pipe section geometry cutting, the cutting method proposed is applicable for any other geometry keeping in mind the factor that during multi-string cutting, maximum bridging material to right side to be maintained, till end of cut, for getting reliable dimensionally correct parts.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the embodiments as described herein.

We claim:

1. A cutting tool (102) comprising:
one or more cutting edges forming a loop with a hollow portion (103), wherein the loop has a configurable shape;
wherein the cutting tool (102) is manipulated by a 4-axis CNC motion system for path planning to achieve sharp inner corners.

2. The cutting tool (102) of claim 1, wherein the cutting tool (102) is mounted on a tool holder (105), wherein the tool holder (105) is mounted on a rotary axis (106) which is controlled by the CNC motion system.

3. The cutting tool (102) of claim 1, wherein the rotary axis (106) is at a center of a bottom cutting edge (111).

4. The cutting tool (102) of claim 1, wherein the rotary axis (106) is at a pre-determined distance from a center of the cutting tool (102).

5. The cutting tool (102) of claim 1, wherein the rotary axis (106) is aligned to a right cutting edge (109) of the cutting tool (102).

6. The cutting tool (102) of claim 1, wherein a width of material to be removed is controlled by manipulating a theta axis among the 4-axis CNC motion system using the cutting tool (102).

7. The cutting tool (102) of claim 1, wherein a tool path (306) followed by the cutting tool (102) for scooping pockets of variable sizes is achieved such that: one of the cutting edges say 109 is always moved along the geometry 300. The opposite cutting edge 110 is manipulated by controlling angle theta, to avoid intersection of the tool with geometry 300 being cut, except for the cutting edge 109.

8. An automatic method of generating tool path for a 4-axis CNC system carrying tool 102 of claim 1, which saves the path 307 of the left edge 110 of the tool.

9. This path 307 which is periphery of the left-over material (if any), is removed by the system in the next cut sequence, by the method explained in claims 7 & 8.

10. The cutting tool (102) of claim 1, wherein a tool path (306) followed by the cutting tool (102) for scooping pockets of variable sizes is achieved with minimum number of strokes and minimum cutting time by manipulating the 4-axis CNC motion system.

11. A method for cutting accurate designs in CNC machines using multiple cutting wires, the method comprising:
generating a tool path such that a maximum bridging material is available between chunk of material (404) and block of raw material (400), wherein a maximum connectivity is maintained to a right-side of the material for achieving geometrical accuracy.

12. An automatic method of generating tool path of the cutting wire, based on criteria of claim 11.

13. An automatic method of generating tool path of the cutting wire, based on criteria of claim 11, specifically for cutting half pipe sections which include single pipe and multiple pipes.

14. An automatic method of generating tool path of the cutting wire, based on criteria of claim 11, specifically for pipe-in-pipe scenario with ODD number of pipes , the method comprising of : The tool path starts from left, cuts all across the half pipe, and overshoots by a small user specified distance (JB in FIG. 10), then move up (BC in FIG. 10), then move left till RIGHT-TOP corner of the inner pipe and start cutting the innermost pipe in Clockwise direction as shown in FIG. 10, then cuts the next bigger pipe and then finally cuts the outer most pipe as shown in FIG. 10.

15. An automatic method of generating tool path of the cutting wire, based on criteria of claim 11, specifically for pipe-in-pipe scenario with EVEN number of pipes , the method comprising of : The tool path starts from left, cuts all across the half pipe, and overshoots by a small user specified distance, then move up (BC in FIG. 11), then move left till LEFT-TOP corner of the inner pipe and start cutting the innermost pipe in Anti Clock Wise direction as shown in FIG. 11, then cuts the next bigger pipe and then finally cuts the outer most pipe as shown in FIG. 11.

16. The automatic method of claim 11, wherein dimensions D1, D2 associated with a pipe are received from user to compensate for kerf width of the pipe.

17. The automatic method of claim 11, wherein an extra vertical cut line is introduced at the end of cutting of each pipe, which shreds the left-over block into discontinuous pieces.
